(19) United States
(12) Patent Application Publication
(10) Pub. No.: US 2004/0157551 A1
(43) Pub. Date: Aug. 12, 2004

(54) Repeater for extending range of time division duplex communication system

(75) Inventors: Kenneth M. Gainey, Satellite Beach, FL (US); James A. Proctor JR., Melbourne Beach, FL (US); John A. Regnier, Palm Bay, FL (US); Jonathan L. Hughes, Melbourne, FL (US); Stefan Haenggi, Niederglatt (CH); Michael J. Lynch, Merritt Island, FL (US)

Correspondence Address: HAMILTON, BROOK, SMITH & REYNOLDS, P.C., 530 VIRGINIA ROAD, P.O. BOX 9133, CONCORD, MA, 01742-9133, US

(73) Assignee: Tantivy Communications, Inc, Melbourne, FL (US)

(21) Appl. No.: 10/601,180

(22) Filed: Jun. 20, 2003

Related U.S. Application Data
(60) Provisional application No. 60/390,094, filed on Jun. 21, 2002.

(51) Int. Cl. H04B 1/60; H04Q 7/20

(52) U.S. Cl. 455/11.1; 455/450; 455/9

(57) ABSTRACT

A repeater that extends the range of a wireless communication system especially one using Time Division Duplex (TDD) protocols. The device preferably translates signals received on a first radio frequency channel to a second radio frequency channel. The repeater preferably monitors one or more channels for transmissions. When a transmission on one channel is detected, the repeater is configured to translate the received signal to another channel where it is then transmitted. The device thus solves a problem of isolating input and output signal from one another.

### RELATED APPLICATION

This application claims the benefit of U.S. Provisional Application No. 60/390,094 filed Jun. 21, 2002. The entire teachings of the above application(s) are incorporated herein by reference.

### BACKGROUND OF THE INVENTION

The present invention relates generally to wireless communication systems and in particular to a technique for distributing wireless signals.

Wireless communication networks of various types, including digital cellular systems, Wireless Local Area Networks (WLANs), and Personal Area Networks such as Bluetooth are increasingly viewed as an ideal connectivity solution for many different applications. These can, for example, be used to provide access to wireless equipped personal computers within home networks, mobile access to laptop computers and Personal Digital Assistants (PDAs) as well as for robust and convenient access in business environments. Indeed it is estimated at the present time that at least 25% of all laptop computers are shipped from the factory with wireless networking equipment already installed. Certain microprocessor manufacturers, such as Intel, have even incorporated wireless capability directly into their processor chip platforms. It is clear that these and other initiatives will continue to drive the integration of wireless equipment into computing equipment and the demand for wireless networks of all types.

In these wireless networks, a central node, referred to as a base station or access point, contains a computer controlled transceiver that allows connection to wired networks such as local area networks, wide area networks or Public Switched Telephone Networks (PSTNs). The access point includes an antenna for transmitting forward link radio frequency signals to remote field units (stations) located within range. The access point is also responsible for receiving reverse link radio frequency signals transmitted from the remote stations. The remote stations also contain antenna apparatus and receivers for reception of the forward link signals and for transmission of the reverse link signals.

One group of wireless local area network equipment standards is known as Institute of Electrical and Electronic Engineers (IEEE) 802.11 family of standards. These standards also support a single hub topology that provides wireless communication to a number of stations. In this architecture, a number of stations may communicate through the air to a single access point, which serves as a gateway to a hard-wired network. Unfortunately, the range of this equipment is typically expected to be limited to under 500 meters. In practice the range is typically much smaller than that, especially when the access point is deployed within a building where signal reflections off of furniture, building contents and even the infrastructure of the building itself are quite common.

There is often a need therefore to increase the coverage area afforded by an access point. This can be accomplished by increasing the height of an antenna, or increasing transmit power levels beyond conventionally accepted norms. However, these solutions cannot remove blind spots. In practice, the ability to increase transmit power level is limited by regulations and by power consumption which effects expected battery.

Another solution is to deploy a greater number of access points to provide coverage in the areas of a building where it is required. While this eliminates blind spots, it of course increases the total capital cost required for network equipment deployment. The cost of WLAN access points has dropped markedly in the past few years, to price points below 100 dollars. But for home users, deployment of more than one or two access points can still be cost prohibitive.

Various types of distribution networks have also been suggested in commercial deployments where multiple remote antennas are connected to centralized equipment. In this approach, such as suggested in U.S. Pat. No. 5,381,459, cable television or fiber optic networks can be used to connect multiple antennas that are deployed within remote coverage areas. This approach couples the remotely deployed antennas to transceivers using time or frequency division multiplexing, in order to avoid interference with the other signals being carried by the cables such as Cable Television (CATV) signals.

Still others have proposed the use of a number of repeating transceivers. Each repeater is assigned a coverage area within a predetermined location. Such repeaters are described to some extent in U.S. Pat. No. 6,005,884. In general, a repeater regenerates a wireless signal in order to extend the range of the existing network infrastructure. A repeater does not physically connect by wire to any other part of the network. Instead the typical repeater receives radio signals from an access point, user device, or another repeater and retransmits them. A repeater located in between an access point and a distant user can thus act as a relay for signals traveling back and forth between the user and the access point.

Certain wireless LAN access points available on the market have repeating functions already built into them, such as the model DWL-900AP access point available from D-Link Systems, Inc of Irvine, Calif. The Air Sation ProSeries WAL-AWCG available from Buffalo Technology, Inc. of Austin, Tex. is another example of a standalone type repeater.

U.S. Pat. No. 5,970,410 discloses a system in which a network of translators are deployed to extend the range of base stations in a wireless communication system. The translators operate in-band, that is, within the frequency channels that are available for use by the operator of the base station. Thus, signals received at one frequency at a translator are shifted to a different assigned frequency channel to be transmitted.

U.S. Pat. No. 6,088,570 describes an extension to the translator concept in which accommodation is made for a Time Division Multiple Access (TDMA) wireless system Here, the in-band translator components include delay elements that implement slot-by-slot delay of signals in order to achieve diversity, that is separation between the time slotted channels.

### SUMMARY OF THE INVENTION

Each of these prior art solutions is less than satisfactory for a number of reasons.

Solutions such as remote antenna drivers for cable television networks are not typically designed for use in home networks or inexpensive installations, but are rather cost effective only for deployment by the operators of public access networks such as cellular telephone network operators.

Repeaters which simply repeat received radio signals potentially reduce network throughput. For example, in the case of a wireless local area network where signals are transmitted and received on the same radio channel, each repeater must receive and then retransmit the repeated signal (data frame) on the same Radio Frequency (RF) channel. This effectively doubles the number of frames that are sent and therefore can reduce the available bandwidth.

Wireless access points that have repeater functionality built into them are not the most cost effective solution, since they incur both the cost of the wireless access point functionality and the associated cost of the repeater in the same unit.

Certain cellular mobile systems and wireless local area networking protocols as well as personal area network protocols separate, receive and transmit (forward and reverse link direction channels) by time rather by frequency. Such systems are known as Time Division Duplex (TDD) systems. Certain of these systems broadcast schedules for transmit and receive channels, and these schedules in turn can be used to switch the repeater. However, this approach would add complexity to the logic in a repeater. In still other applications, the exact time of receive and transmit is not known, due to the fact that the access points do not broadcast such timing and/or because of physical separation, multipath an additional delay and the like it is not possible to determine the same.

Certain local area network and personal area network protocols use collision avoidance schemes. In these collision avoidance schemes, a node desiring to transmit first checks to see if it can detect any activity from other nodes. If no activity is seen, then a node proceeds to transmit. If activity is detected, a wait time associated with a random number is used before attempting to transmit again. These schemes, variously referred to as collision avoidance with random back off protocols, therefore make the exact needed timing of any repeater re-transmissions unpredictable.

Most repeater applications face an additional problem in that some form of isolation typically should be provided between the receiver and transmitter. One approach is to employ directional antennas and/or to provide physical separation of two different receiving transmit antennas to achieve isolation. However, in some applications, this is not practical because of the added cost and/or necessary connections between transmit and receive antennas.

The present invention is an approach to implementing a repeater for Time Division Duplex (TDD) wireless system in which at least one radio channel is monitored for signals received from an access point. Upon detecting that a signal is present, the received transmission is then retransmitted. In a preferred embodiment, a delay is associated with the repeated transmission that is equal to or greater than the received signal detection time. The delay is not otherwise dependent upon characteristics of the received signal (such as a slot time or packet length). The delay isolates the transmitted portion from the received signal allowing for improved performance in certain cellular telephone and wireless local area network applications.

In a preferred embodiment, a different frequency is used for the retransmission delay, and this frequency difference is at least one channel spacing. In still other applications, re-transmission may occur with a small frequency offset.

In certain embodiments, a single antenna may be used; in other embodiments, two different antennas may be used for transmit and receive, and/or directional antennas may also be employed to further obtain isolation between the receive and transmit paths.

The approach is useful in wireless local area networks that use Time Division Duplex (TDD) protocols, where a particular unit may be transmitting or receiving, but not both, at the same time. These can include wireless local area network protocols such as the IEEE 802.11 based protocols, Bluetooth personal area network protocols, or cellular telephone protocols such as TD-SCDMA, TDD-W-CDMA and the like. However, the approach can also be used with other types of networks.

### BRIEF DESCRIPTION OF THE DRAWINGS

FIG. 1 is a schematic diagram of a situation in which coverage of a wireless system may be extended with a repeater.

FIG. 2 is a view of a preferred package for the repeater.

FIG. 3 is detailed block diagram of a repeater constructed according to the invention.

FIG. 4 is a timing diagram that illustrates how the radio frequency signal is delayed before re-transmission.

FIG. 5 is an alternate embodiment using frequency offset and also using antenna arrays.

### DETAILED DESCRIPTION OF THE INVENTION

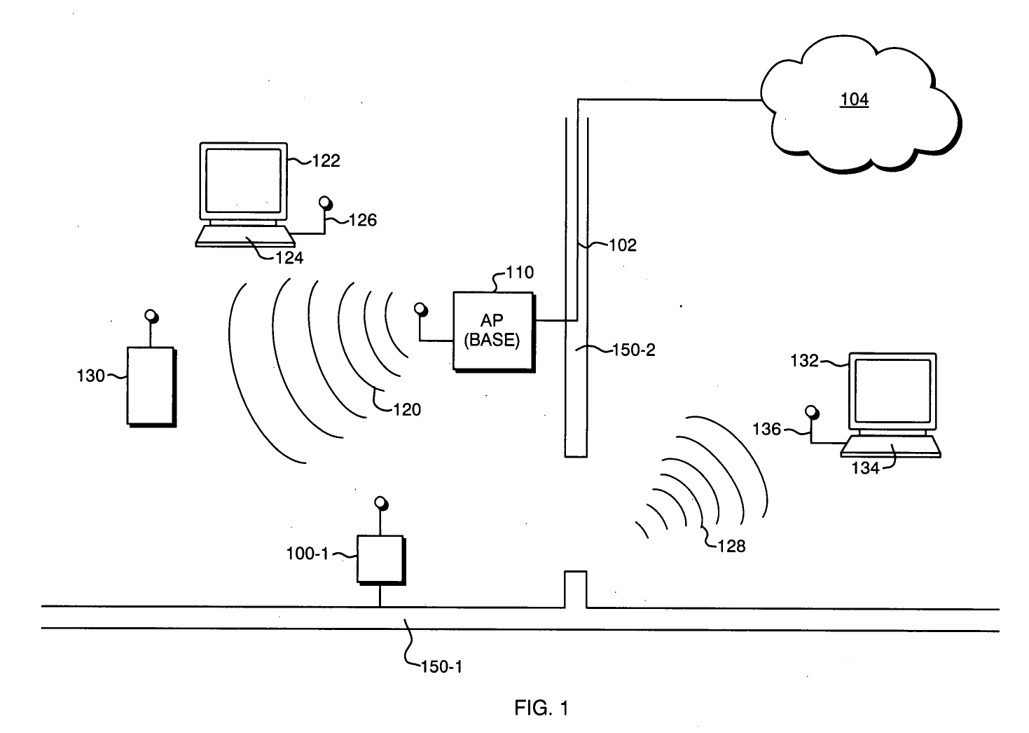

Turning attention now to the drawings, FIG. 1 is a schematic diagram of a building in which a repeater 100 is deployed according to the present invention. As is now quite common, a broadband network connection 102 such as may be provided by a cable modem, Digital Subscriber Line (DSL) telephone line, or other wired accesses point is provided to a broadband network 104 such as the Internet or private or a Public Switch Telephone Network (PSTN). An access point (AP) 110, also referred to as a base station, is connected to the broadband connection 102. The access point 110 provides or radiates wireless signals 120 within a defined area of the building. Wireless signals 120 provide wireless data connectivity to, for example, a laptop computer 122, having associated with it wireless interface card 124 and antenna 126. Other devices such as hand held mobile telephone 130 may also be able to communicate with the access point 110. The mobile telephone 130 is representative device only it should be understood that other small devices such as Personal Digital Assistance (PDAs), and combination PDA/cellular telephone devices may also be utilized.

The wireless network 120 in the illustrated embodiment uses a Wireless Local Area Network (WLAN) protocol such as those defined by the 802.11a, 802.11b, or 802.11 g standards. These Time Division Duplex (TDD) methods cause both transmit and receive signaling on the same Radio Frequency (RF) channel. It should be understood that emerging cellular telephone protocols such as those defined in the Third Generation (3G) standards known as TDS-CDMA, TDD-WCDMA, and other cellular telephone standards may also use TDD methods to provide wireless connectivity. Still other types of wireless networks such as Bluetooth, Hyperlan and the like also use TDD signaling.

A second portable computer 132 is also located in the building and also having a wireless access card 134 and antenna 136, but is in a different room. It is therefore outside direct the range of the access point 110 given that walls 150-1 and 150-2 are attenuating the RF signals 120 radiating directly from the access point 110. Thus no signals 120 will directly reach portable computer 132 from the access point 110.

However, the repeater 100 cooperates to extend the range of the access point 110 so that re-radiated wireless signals 128 can reach the portable computer 132. In this implementation, the repeater 100 is plugged into an electrical outlet within the building such as within or along the wall 150-1. As will be understood shortly, the repeater 100 is preferably packaged in a most convenient form factor, as an Alternating Current/Direct Current (AC/DC) converters or “wall wart” that can be conveniently inserted into an electrical power outlet in a manner that is quite familiar to consumers.

The present invention relates to techniques that prevent oscillation, that is, coupling between the radio input and output of the repeater 100. This separation is often desirable in order to achieve enough attenuation between the transmit and receive paths through the repeater 100, in order to keep regenerative feedback from preventing the repeater to work.

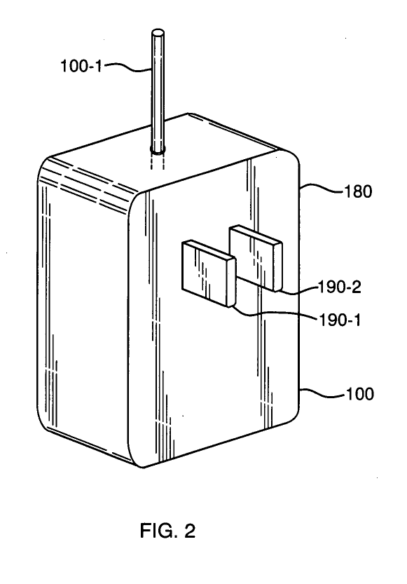

FIG. 2 is a more detailed view of a typical repeater 100 and its housing. As seen, a familiar AC/DC power converter package 180 is typically formed of a thermoplastic housing. Prongs (plugs) 190-1, 190-2 provide connectivity to an AC power source. This package is typical of the small power supply brick having an integral male plug designed to plug directly into a common wall outlet. These packages are sometimes called “wall warts” because when installed in the wall plug or on a power strip, they tend to block off at least one more socket than they actually use. These packages are frequently associated with the necessary power supply for small electronic devices such as modems, re-chargers for cellular telephones and small hand-held household appliances which would otherwise become unacceptably bulky or hot if they had included the power supplies onboard.

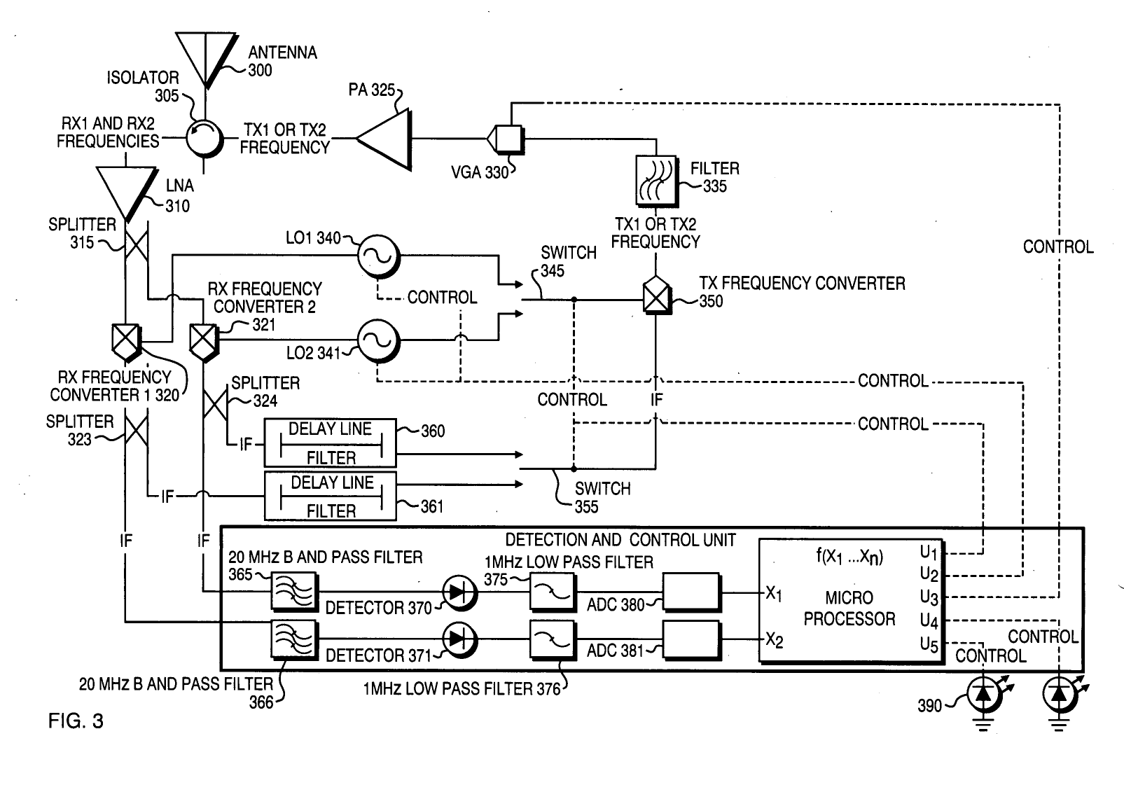

FIG. 3 is a circuit diagram of a preferred embodiment of the electronics inside the repeater 100. In this preferred embodiment, the repeater 100 is capable of receiving signals on at least two different frequency channels simultaneously. If activity is present on a receiving channel, the repeater 120 delays such reception and also preferably translates its frequency to a radio frequency channel in which activity is not present. The unit then retransmits the signal.

More particularly, the repeater 100 consists of at least one resonating element, such as an antenna 300, an isolator 305, and receive signal processing elements including a Low Noise Amplifier (LNA) 310, splitter 315, a frequency conversion device, such as mixes 320 and 321, further splitters 323 and 324, delay line filters 360, 361, and switch 355. A pair of local oscillators 340 and 341 are also selected under control of switch 345. A transmit signal processing portion includes a transmit frequency converter 350, transmit filter 335, Variable Gain Amplifier (VGA) 330, and Power Amplifier (PA) 325.

Detection and control circuitry, consisting of bandpass filters 365, 366, detectors 370, 371, low pass filters 375, 376, Analog to Digital Converters (ADCs) 380, 381, and microprocessor controller 385 are used to generate various control signals. As will be understood shortly, these control signals select the operation of various other components such as the switches, local oscillators, variable gain amplifiers and the like.

In operation, radio waves that are incident to the antenna 300 are fed first to the isolator 305. The isolator 305 provides for separation between transmit and receive signal paths in a manner that is well known; it is possible that other similar devices such as duplexers, diplexers and the like can also provide for such required separation. After amplification by amplifier 310, the receive signal is split into two paths by a splitter 315, each at equal power. Other similar devices such as directional couplers and the like can also be used in place of splitter 315.

The Radio Frequency (RF) signals from each leg of the splitter 315 are next fed to a pair of RF mixers 320 and 321. The mixers operate under the control of two different local oscillators 340, 341. The local oscillators are each tuned to different frequencies such that two different signals at two different Intermediate Frequencies (IFs), LO1 and LO2, result at the output of the mixers. In a preferred embodiment, if the two different input channels being processed are wireless local area network signals in accordance with 802.11b for example, at carrier frequencies of 2.412 GigaHertz (GHz) and 2.462 GHz, local oscillator 340 may be tuned to 2.432 GHz and local oscillator 341 tuned to 3.532 GHz. In this case the two separate outputs at 320 and 321 would then be translated to an IF of approximately 70 MegaHertz (MHz).

The further splitters 323, 324 then operate to separate the IF signal into two paths. One path is associated with providing an output radio frequency signal, and the other path is associated with detection of signals that are used to determine activity.

The first path, the RF transmit chain, forwards the IF signal first to delay lines 360 and 361. These devices, which are bandpass filters that provide a delay serve at least two functions. The first is to filter modulation products that are not associated with the desired output, i.e., the detected channel information.

In the preferred embodiment, these filters also provide a time delay, with the time delay being sufficiently long such that the detection and control circuitry 400 associated with determining the presence of activity can complete its operation. That is, the delay is sufficiently long enough to determine if energy is present on either of the two input channels before output signals are provided.

The delay does not otherwise depend upon characteristics of the received signal itself. That is, unlike other prior art systems, the delay does not relate to physical parameters of the transmitted signals, such as a time slot duration; nor does it relate to other medium access layer, network layer, or application layer characteristics, such as a burst or packet length.

The other IF path bandpass filters 365 and 366 provide a first portion of the signal presence detection function, in connection with the diode detectors 370 and 371. These components thus detect if a signal present on either of the two input frequency channels, providing a proportional output voltage at low pass filters 375 and 376 accordingly. Other types of detection circuits are possible although the simple circuit shown here is probably preferred if cost is to be as low as possible. Such other devices could include matched filters, surface acoustic wave devices, correlators and the like to determine if the detected signal is a WLAN signal or noise or some unwanted signal.

The low pass filters 375 and 376 remove high frequency components that might remain after detection, thereby leaving a signal that is associated with a power envelope of any detected energy.

The ADCs 380 and 381 provide digital signals to the microprocessor 385. The microprocessor 325, which may be a digital signal processor or other microprogramable controller or logic circuit, determines when the detected voltage is above the predetermined threshold indicating activity. In such an instance, the switches 345, 355 are operated accordingly to allow selection of one of the delay line filter 360 or 361 outputs depending upon the channel in which activity was detected. It should be understood that other detection circuits could also include peak detectors, adjustable threshold controls, logarithmic amplifiers and the like.

The microprocessor 305 can also provide an indication of repeater operability to a user. In this simplest embodiment, this indication is provided by Light Emitting Diodes (LEDs) 390, 391. The LEDs are activated when an RF output is provided. However, a more complex form of information is provided by a display which indicates a relative signal strength indication and/or the like. Such a display could be used to assist an end user to confirm that the repeater 100 is being placed in a location that actually improves reception at computer 132.

An additional switch 345 controls one of the two local oscillators 340 or 341. The selected local oscillator switch is then fed to the transmit frequency converter mixer 350. Thus, for example, if activity is detected on the LO1 (F1) channel, the switch 345 is operated so that oscillator 341 (LO2) is selected to produce the transmit signal. In the other situation where activity is associated with F2, then the switch 345 is operated to the upper position to select the output of local oscillator 340 LO1. In either event, the frequency converter mixer 350 up bands the IF signal to determine the final RF transmit frequency.

As one example, using the frequencies from the previously discussed example, assuming F1 is 2.412 GHz, F2 is 2.462 GHz, and the IF of 70 MHz, LO1 is selected to be 2.342 GHz and LO2 is set at 2.532 GHz.

If activity is detected on F1 at 2.412 GHz, then the active signal will be associated with delay line filter output 361. The switch 355 is then operated to select that signal, and switch 345 is selected to connect to the output of oscillator 341. The output of mixer 350 is thus the two components associated with LO1-IF and LO2+IF, with the desired component being LO2-IF, i.e., at 2.462 GHz.

Since the mixer 350 provides both the sum and difference term of the signals produced by switch 345 and switch 355, then a transmit filter 335 is necessary to remove the undesirable frequency product. In the examples discussed the undesired frequency modulation product is at 2.602 GHz. A sufficient bandpass is associated with filter 335 to remove such modulation products.

The translated version of the received signal is then ready to be applied to the antenna 300 for transmission. First, however, it is fed to a Variable Gain Amplifier 330 that provides a variable amount of appropriate gain under control of the microprocessor 385. This ensures that the signal being fed to the power amplifier 325 is within the desired transmit power range. The power amplifier 325 provides for final power amplification coupling its output signal to the transmit leg of the isolator 305. From this point, the radio frequency wave is the propagated by the antenna 300.

It should also be understood that the circuit illustrated is bi-directional for Time Division Duplex (TDD) systems such as 802.11 WLANs. For example, a received signal received on a first channel, F1, is re-transmitted on a second channel, F2. IN addition, a signal received on the second channel, F2, is also re-transmitted on the first channel, F1.

While the above description assumes only two frequency channels F1 and F2 are available, it is possible that additional frequency channels could be utilized with the addition of further but similar signal processing chains. For example, in some WLAN implementations, signals may be sent by the access point on up to twelve channels. Thus, it may be advantageous to monitor all twelve channels at the same time. In such a case where multiple channels are monitored, additional down converters 320, 321, splitters 323, 324, delay lines 360, 361, and detection circuits including fitters 365, 366, diodes 370, 371, filters 375, 376 and ADCs 380, 381 are used to cover the added channels. This architecture permits activity to be detected on any possible receive channel at any instant in time.

In other embodiments, it may be possible to have fewer receive signal processing components and scan the channels one at a time.

While in the embodiment described above, fixed local oscillators determined the exact operation frequency, it should be understood that variable oscillator (under control of the microprocessor 385) could also be used so that the repeater can be operated at any available frequency channels.

In certain Time Division Duplex (TDD) systems, the use of delay lines 360, 361 enhance the operation of the repeater. In such environments, which occur in 802.11-type systems, the exact time at which a received signal can be expected is unknown. As long as the delay 360, 361 is long enough to permit the detector and control unit (e.g., ultimately the micro controller, 385) to determine that a signal is being received, the repeater can then re-transmit the received signal.

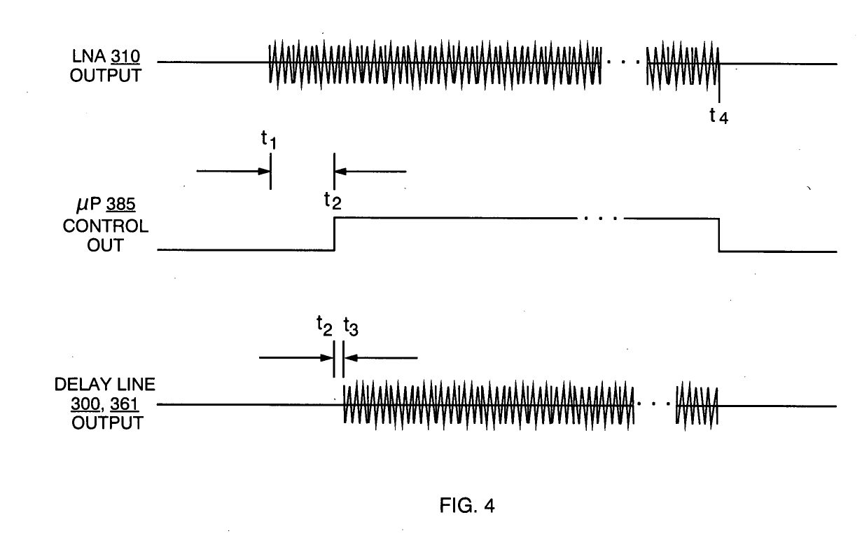

This is illustrated in the timing diagram of FIG. 4. The top signal trace illustrates an RF signal which begins to be received at time t₁, say at the output of the LNA 310. The various splitters 315, frequency converters 320, 321, splitters 323, 324, and detection and control circuitry process the received signal with the micro controller 385 asserting an output/control signal (the second signal trace in FIG. 4) at time t₂. The delay line 360, 361 output should this begin no earlier than time t₂, and can be at a later time, t₃.

A frequency translation from F1 to F2 is preferred, as previously described. This permits the output transmitted RF signal (lowest trace in FIG. 4) to over lap in time with the received signal. Otherwise, for example, in a WLAN system, an entire packet time (until time t₄) would have to expire before the output RF could be provided on the same radio channel without interfering with the received signal.

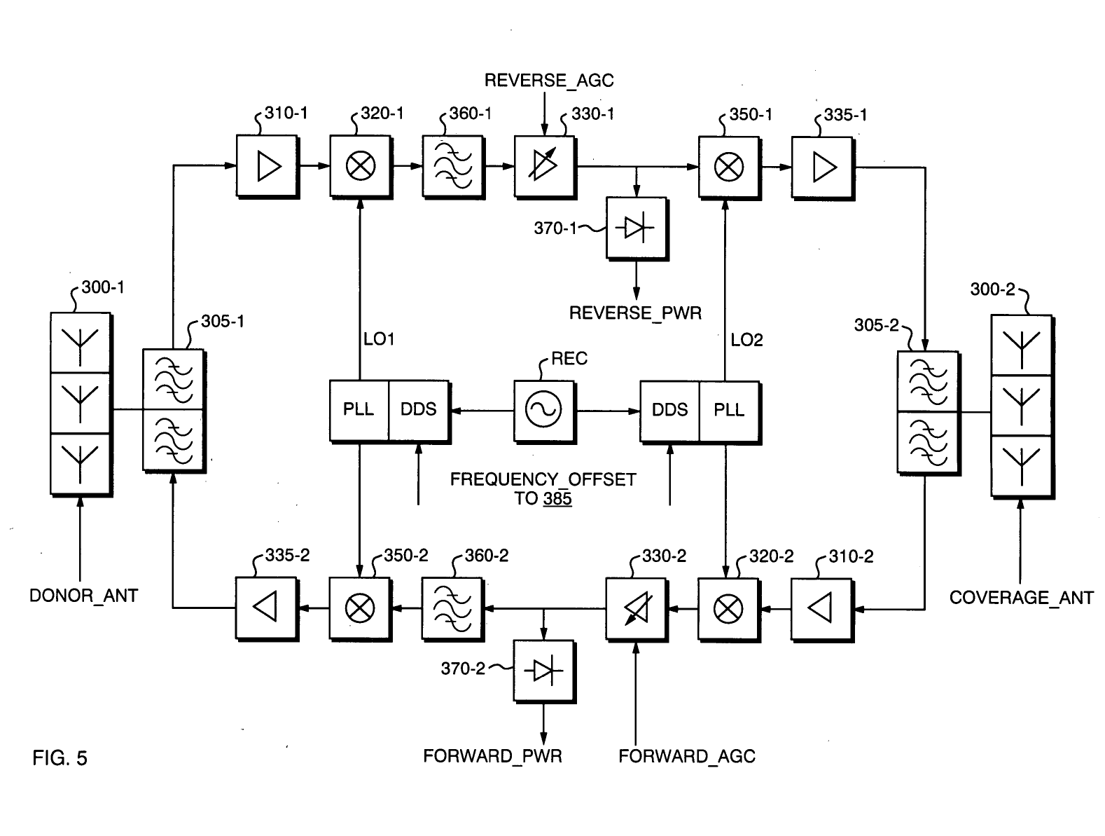

FIG. 5 is an alternate embodiment in which the frequency shift need not be as much as a full channel spacing, this embodiment also illustrates the use of separate donor and coverage antennas, as well as two complete signal processing paths, which eliminates the use of switches.

A donor antenna 300-1 is coupled to a duplexer 305-1 to separate out receive and transmit signals. The donor antenna 300-1 is generally intended to provide coverage towards the access point 110 (in FIG. 1) the coverage antenna 300-2 provides coverage in the area of the portable computer 132.

A receive LNA 310-1, mixer 320-1, filter 360-1, AGC amplifier 33D-1 and power detector 370-1 determine the presence of an input signal, a unit similar to the functions of the analogue components in the embodiment of FIG. 3. Once signal energy is detected at 320-1, the reference oscillator (REF) and Direct Digital Synthesizer (DDS) and Phase Locked Loop (PLL) provide signal LO2 used to upconvert at mixer 350-1. The RF output signal is provided through power amplifier 335-1 and duplexer 305-1 to coverage antenna 300-2.

Signals received at coverage antenna 300-2 are propagated through duplexer 305-2, LNA 310-2, mixer 320-2, AGC 330-2, detector 370-2, fitter 360-2, mixer 350-2, amplifier 335-2 and duplexer 305-1 in the same fashion.

In this embodiment, the frequency offset between the two RF frequencies is determined by the reference REF and DDS's. It can be a whole frequency channel, which is preferred in the case of a TDD system, but it may be a smaller offset.

One or more of the antennas 300-1 and 300-2 may be directed arrays, which can be used to further provide isolation between the donor side and coverage side.

While this invention has been particularly shown and described with references to preferred embodiments thereof, it will be understood by those skilled in the art that various changes in form and details may be made therein without departing from the scope of the invention encompassed by the appended claims.

What is claimed is:

1. A repeater device for a wireless network comprising:
a detector, for determining if a signal is being received on a monitored radio frequency channel;
a delay for delaying said received signal while detecting same, the delay being at least equal to a time need for the detector to determine if a signal is being received; and
a transmitter, for re-transmitting the delayed received signal.

2. A repeater device as in claim 1 wherein the repeater device is packaged in a power converter housing.

3. A repeater device as in claim 1 wherein the delayed received signal is re-transmitted on a different frequency channel than the received signal.

4. A repeater device as in claim 1 wherein the delayed received signal is re-transmitted on a carrier frequency that is different from the carrier frequency of the monitored radio frequency channel.

5. A repeater device as in claim 1 wherein a single antenna is used for receiving signals on the monitored channel and for re-transmitting signals.

6. A repeater device as in claim 1 wherein a separate antenna is used for receiving signals on the monitored channel and for re-transmitting signals.

7. A repeater device as in claim 1 wherein the received signal is a Time Division Duplex (TDD) type signal such that signals are not transmitted and received by the same device at the same time on the same frequency.

8. A repeater device as in claim 6 wherein at least one antenna is a directional antenna.

9. A repeater device as in claim 1 wherein the detector determines if the received signal is present on one of at least two monitored channels.

10. A repeater device as in claim 1 wherein the detector determines if the received signals is present on one of twelve monitored channels.

11. A repeater device as in claim 1 additionally comprising:
a down-converter, for processing the received signal to produce an Intermediate Frequency (IF) received signal.

12. A repeater device as in claim 11 wherein the detector is a diode detector coupled to the IF received signal.

13. A repeater device as in claim 11 wherein the detector is a matched filter coupled to the IF received signal.

14. A repeater device as in claim 1 wherein the detector is a diode detector coupled to the received signal.

15. A repeater device as in claim 1 wherein the detector is a matched filter coupled to the received signal.

16. A repeater device as in claim 1 wherein the transmit frequency may be one of the receive channel frequencies.

17. A repeater device as in claim 1 wherein the received signal arrives at the repeater from a first direction, and the transmitted signal is sent in a second direction.

18. A repeater device as in claim 7 wherein a received signal received on a first channel, F1, is re-transmitted on a second channel, F2, and a signal received on the second channel, F2, is re-transmitted on the first channel, F1.
